(19) United States
(12) Patent Application Publication
(10) Pub. No.: US 2010/0013719 A1
(43) Pub. Date: Jan. 21, 2010

(54) Antenna and an electronic device having the antenna

(75) Inventors: Li-Jean Yen, Taipei Hsien (TW); Chia-Tien Li, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/385,474

(22) Filed: Apr. 9, 2009

(30) Foreign Application Priority Data
Jul. 15, 2008 (TW) 097126769

(51) Int. Cl. H01Q 9/04; H01Q 1/50; H01Q 1/24

(52) U.S. Cl. 343/702; 343/700 MS; 343/860

(57) ABSTRACT

An antenna and an electronic device having the antenna are disclosed. The antenna comprises: a base board having a first surface and a second surface; a first radiating element disposed on the first surface; a grounding element disposed on the first surface; a feeding structure disposed on the first surface, wherein the first radiating element is electrically coupled with the feeding structure and the grounding element; and a second radiating element disposed on the first surface or the second surface, wherein the second radiating element adjusts a first resonant mode or generates a second resonant mode by inductive coupling.

### BACKGROUND OF THE INVENTION

1. Field of the Invention

The present invention relates to an antenna and an electronic device having the antenna, and more particularly, to an inductive coupling antenna and an electronic device having the inductive coupling antenna.

2. Description of the Related Art

With the evolution of wireless communication technology, various portable devices such as cellular phones, global positioning systems, personal digital assistants and notebook PCs are broadly exploiting wireless communication technology for data transmission; besides, as more and more information is transmitted via wireless networks, there have been explosive demands for wireless bandwidth.

There are many wireless communication techniques such as UWB, WiMAX, WiFi or 3G wireless communication proposed to operate in different frequency bands. Therefore, in order to cooperate with different wireless communication techniques, it has now become a trend for manufacturers to provide antennas having multi-frequency reception capabilities.

Meanwhile, these portable communication devices are required to be lighter and smaller, and the antenna must also be reduced in size in order to be installed into these electronic devices.

In prior art there has disclosed a monopole antenna formed in graded triangle which can provide broad bandwidth. Please refer to FIG. 1A and FIG. 1B for an antenna disclosed in prior art. As shown in FIG. 1A, the prior art antenna 90 comprises a radiating element 91, a grounding element 92 and a feeding structure 93. The radiating element 91 is formed in graded triangle to provide broad bandwidth. However, according to the voltage standing wave ratio (VSWR) as illustrated in FIG. 1B, the antenna 90 has only one resonant mode with an approximate bandwidth of 40% and a central frequency of 5.3 GHz, therefore the antenna 90 does not meet the multi-frequency requirement.

Therefore, it is necessary to provide a broadband antenna with improved operating bandwidth and decreased size to overcome the deficiencies in the prior art techniques.

### SUMMARY OF THE INVENTION

In order to deal with problems associated with prior art techniques, the present invention provides an antenna and an electronic device having the antenna to improve bandwidth, increasing operating frequency bands and to decrease device size.

The invention discloses an electronic device comprising a wireless transmission module and an antenna. The antenna is electrically coupled with the wireless transmission module. The antenna comprises a base board, a first radiating element, a grounding element, a feeding structure and a second radiating element. The base board has a first surface and a second surface; the first radiating element, the grounding element and the feeding structure is disposed on the first surface; the first radiating element, the feeding structure and the grounding element is electrically coupled with each other to generate a first resonant mode by direct excitation; the second radiating element is disposed on the first surface or the second surface, the second radiating element adjusts a first resonant mode or generates a second resonant mode by inductive coupling.

In an embodiment of the invention, the base board is a printed circuit board for the first radiating element, the grounding element and the second radiating element to be printed on the base board.

In an embodiment of the invention, the second radiating element is essentially rectangular; the second radiating element is disposed on the second surface; and the second radiating element has a projected area at least partially overlapping with a corresponding projected area of the first radiating element. Therefore, the first radiating element can enable impedance match by capacity effect to adjust the first resonant mode.

In an embodiment of the invention, the second radiating element is essentially in L shape or in U shape; the second radiating element is disposed on the second surface; the second radiating element is electrically coupled with the grounding element; the second radiating element has a projected area not overlapping with a corresponding projected area of the first radiating element. Therefore the second radiating element generates a second resonant mode by inductive coupling.

In an embodiment of the invention, a third radiating element is disclosed, the third radiating element is disposed on the second surface to enable impedance match by capacity effect to adjust the first resonant mode; the third radiating element has a projected area at least partially overlapping with a corresponding projected area of the first radiating element. The second radiating element is essentially in L shape or U shape, the third radiating element is essentially rectangular, and the second radiating element essentially surrounds the third radiating element.

### BRIEF DESCRIPTION OF THE DRAWINGS

FIG. 1A illustrates a view of an antenna in the prior art;

FIG. 1B illustrates a VSWR (voltage standing wave ratio) diagram of the antenna in the prior art;

FIG. 2A illustrates a front view of an antenna in a first embodiment;

FIG. 2B illustrates a back view of the antenna in the first embodiment;

FIG. 2C illustrates a VSWR diagram of the antenna in the first embodiment;

FIG. 3A illustrates a front view of an antenna in a second embodiment;

FIG. 3B illustrates a back view of the antenna in the second embodiment;

FIG. 3C illustrates a VSWR diagram of the antenna in the second embodiment;

FIG. 3D illustrates another implementation view of the antenna in the second embodiment;

FIG. 4A illustrates a front view of an antenna in a third embodiment;

FIG. 4B illustrates a back view of the antenna in the third embodiment;

FIG. 4C illustrates a VSWR diagram of the antenna in the third embodiment;

FIG. 4D illustrates a front view of an implementation of the antenna in the third embodiment;

FIG. 4E illustrates a back view of the implementation of the antenna in the third embodiment;

FIG. 5A illustrates a front view of an antenna in a fourth embodiment;

FIG. 5B illustrates a back view of the antenna in the fourth embodiment;

FIG. 5C illustrates a VSWR diagram of the antenna in the fourth embodiment;

FIG. 5D illustrates a front view of an implementation of the antenna in the fourth embodiment;

FIG. 5E illustrates a back view of the implementation of the antenna in the fourth embodiment; and

FIG. 6 illustrates a view of a system block of an electronic device in the invention.

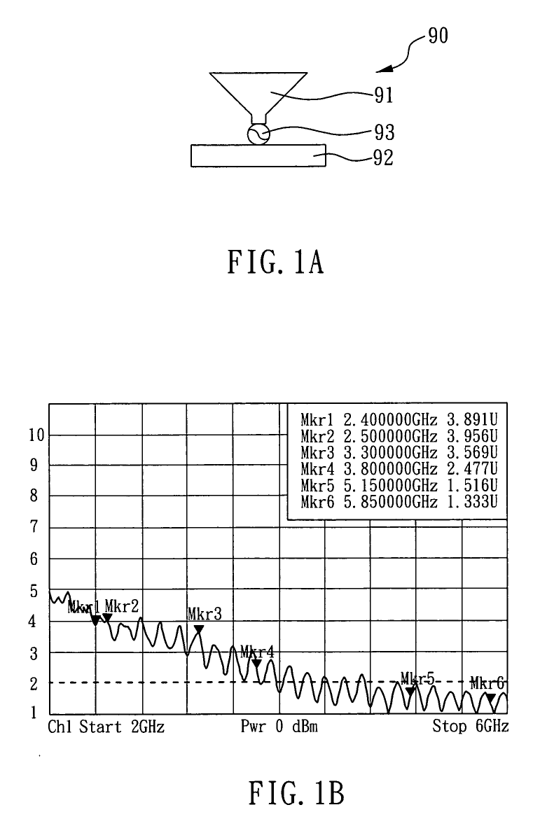

### DETAILED DESCRIPTION OF THE PREFERRED EMBODIMENT

The advantages and innovative features of the invention will become more apparent from the following detailed description when taken in conjunction with the accompanying drawings.

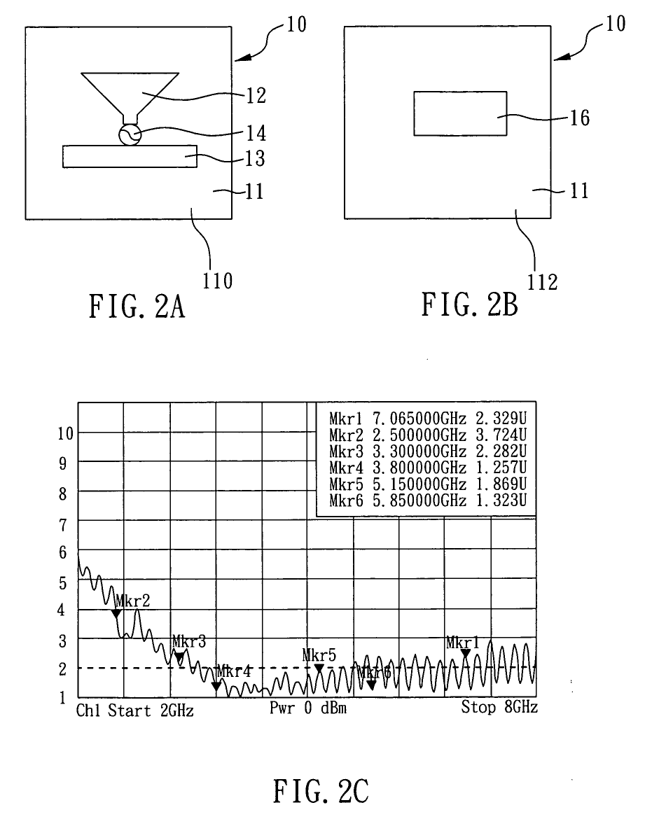

Please refer to FIG. 2A to FIG. 2C for views of an antenna in a first embodiment of the invention, wherein FIG. 2A illustrates a front view of an antenna in the first embodiment; FIG. 2B illustrates a back view of the antenna in the first embodiment; and FIG. 2C illustrates a VSWR diagram of the antenna in the first embodiment.

As shown in FIG. 2A and FIG. 2B, an antenna 10 comprises a base board 11, a first radiating element 12, a grounding element 13, a feeding structure 14 and a second radiating element 16. The base board 11 comprises a first surface 110 and a second surface 112, wherein the first radiating element 12, the grounding element 13 and the feeding structure 14 are disposed on the first surface (front surface) 110 of the base board 11; the second radiating element 16 is disposed on the second surface (back surface) 112 of the base board 11.

The base board 11 can be a printed circuit board made of FR4 (Flame Retardant 4) class glass fiber to meet design requirements of common electronic products; the first radiating element 12, the grounding element 13 and the second radiating element 16 are disposed on the base board 11 by, but not limited to, printing them thereon.

As shown in FIG. 2A, the first radiating element 12 is in the shape of, but not limited to, an inverted triangle. The first radiating element 12 can have any shape such as a trapezoid. As shown in FIG. 2B, the second radiating element 16 is in the shape of, but not limited to, a rectangle. The second radiating element 16 can have any shape such as a triangle or a pentagon.

The first radiating element 12 is electrically coupled with the feeding structure 14 and the grounding element 13, however, the invention is not limited to any electrical coupling implementation; for example, the first radiating element 12 is electrically coupled with the grounding element 13 through a connecting element (not shown in figure). The feeding structure 14 comprises a feeding point (not shown in figure), the feeding point is electrically coupled with a feeding line (not shown in figure) for transmitting an electrical signal to the first radiating element 12. The first radiating element 12 generates a first resonant mode by direct excitation. The feeding line can be, but not limited to, an RF Cable.

As shown in FIG. 2A and FIG. 2B, the second radiating element 16 on the second surface 112 has a projected area at least partially overlaps with a corresponding projected area of the first radiating element 12 on the first surface 110. The antenna 10, through inductive coupling of the overlapping capacity effect between the first radiating element 12 and the second radiating element 16, enables impedance match to adjust the first resonant mode, therefore the antenna 10 in the invention provides broader bandwidth compared with that of the prior art antenna 90.

FIG. 2C illustrates a VSWR diagram of the antenna 10 under different frequencies. It is known from the figure that the frequency for the antenna 10 to generate the first resonant mode is between 3.6 GHz and 5.6 GHz with a central frequency of: (3.6 GHz+5.6 GHz)/2=4.6 GHz, the bandwidth is: (5.6 GHz−3.6 GHz)/4.6 GHz=43%. Therefore, compared with the prior art antenna 90, the antenna 10 can generate a resonant mode at a lower frequency band with a broader bandwidth.

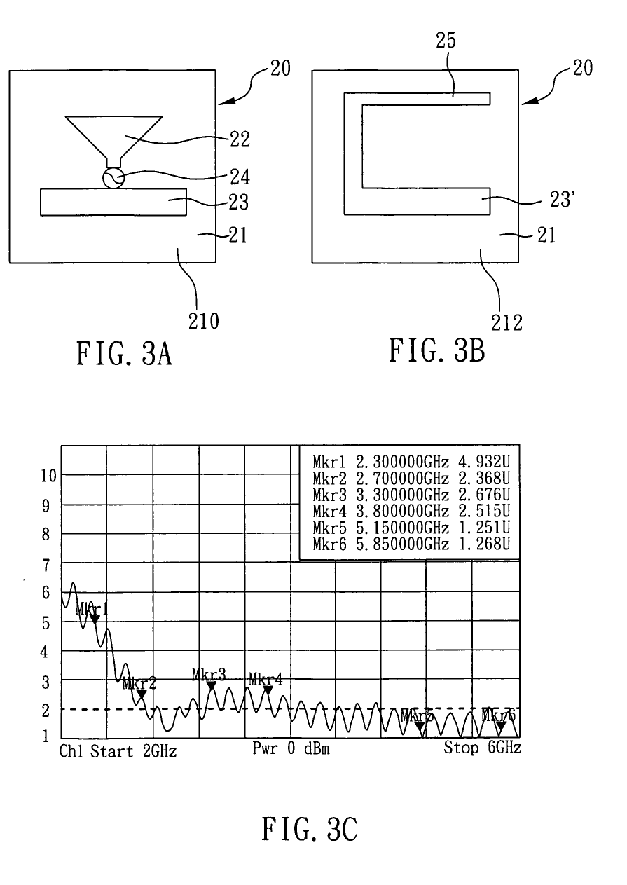

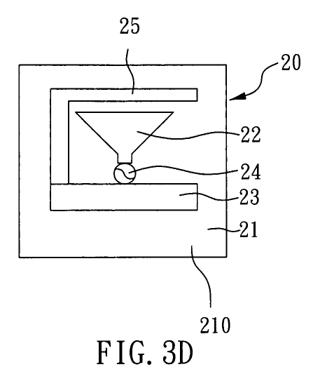

Now please refer to FIG. 3A to FIG. 3D for views of an antenna in a second embodiment of the invention, wherein FIG. 3A illustrates a front view of an antenna in the second embodiment; FIG. 3B illustrates a back view of the antenna in the second embodiment; FIG. 3C illustrates a VSWR diagram of the antenna in the second embodiment; and FIG. 3D illustrates another implementation view of the antenna in the second embodiment.

As shown in FIG. 3A and FIG. 3B, an antenna 20 comprises a base board 21, a first radiating element 22, a grounding element 23 and 23′, a feeding structure 24 and a second radiating element 25. The base board 21 comprises a first surface 210 and a second surface 212, wherein the first radiating element 22, the grounding element 23 and the feeding structure 24 are disposed on the first surface (front surface) 210 of the base board 21; the second radiating element 25 and the grounding element 23′ are disposed on the second surface (back surface) 212 of the base board 21.

The difference between the second embodiment and the first embodiment is that, in the second embodiment, the second radiating element 25 is electrically coupled with the grounding element 23′, and the second radiating element 25 is electrically coupled with the grounding element 23 on the first surface 210 through the grounding element 23′. Besides, the second radiating element 25 on the second surface 212 has a projected area not overlapping with a corresponding projected area of the first radiating element 22 on the first surface 210.

Therefore, the second radiating element 25 is a parasitic radiating element extending from the grounding element 23 to generate a second resonant mode for antenna 20 through inductive coupling and excitation. The antenna 20 provides multi-frequency transmission capability compared with the prior art antenna 90 and the antenna 10 in the first embodiment.

As shown in FIG. 3B, the second radiating element 25 is in L shape; however, the second radiating element 25 can have any shape such as a U shape.

FIG. 3C illustrates a VSWR diagram of the antenna 20 under different frequencies. It is known from FIG. 3C, when VSWR is less than 2, the antenna 20 generates a first resonant mode between 4.7 GHz and 6.0 GHz; and the antenna 20 generates a second resonant mode between 2.8 GHz and 3.0 GHz. Therefore, compared with the prior art antenna 90 and the antenna 10 in the first embodiment, the antenna 20 can generate two resonant modes and also provides multi-frequency transmission capability.

Furthermore, as shown in FIG. 3D, the second radiating element 25 can be disposed not only on the second surface (back surface) 212, but also on the first surface 210 so as to be electrically coupled with the grounding element 23 directly and to achieve the effect of the invention as well.

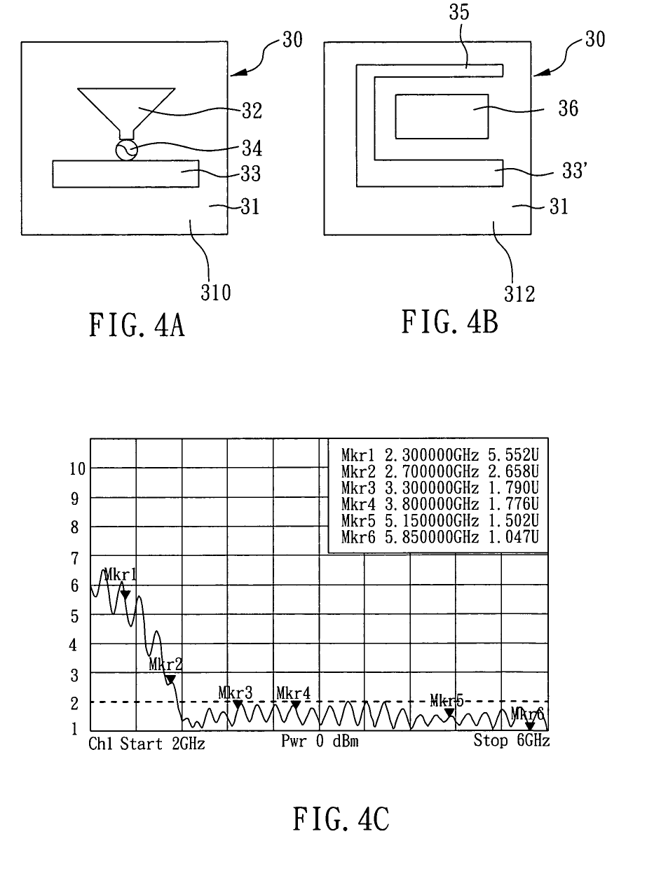

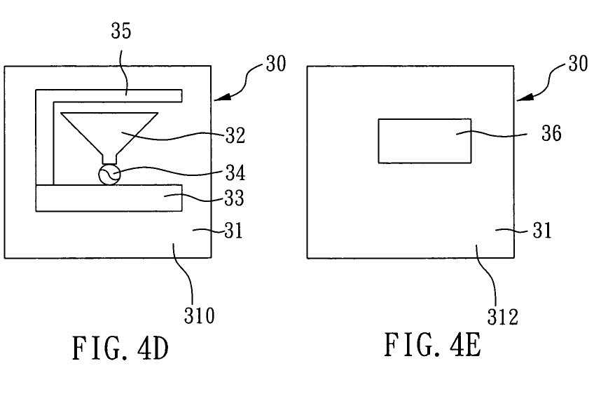

Now please refer to FIG. 4A to FIG. 4E for views of an antenna in a third embodiment of the invention, wherein FIG. 4A illustrates a front view of an antenna in the third embodiment; FIG. 4B illustrates a back view of the antenna in the third embodiment; FIG. 4C illustrates a VSWR diagram of the antenna in the third embodiment; FIG. 4D illustrates a front view of an implementation of the antenna in the third embodiment; and FIG. 4E illustrates a back view of the implementation of the antenna in the third embodiment.

As shown in FIG. 4A and FIG. 4B, an antenna 30 comprises a base board 31, a first radiating element 32, a grounding element 33 and 33′, a feeding structure 34, a second radiating element 35 and a third radiating element 36. The base board 31 comprises a first surface 310 and a second surface 312, wherein the first radiating element 32, the grounding element 33 and the feeding structure 34 are disposed on the first surface (front surface) 310 of the base board 31; the second radiating element 35, the grounding element 33′ and the third radiating element 36 are disposed on the second surface (back surface) 312 of the base board 31.

The difference between the third embodiment and the second embodiment is that, in the third embodiment, the antenna 30 further comprises the third radiating element 36, and the second radiating element 35 is essentially surrounding the third radiating element 36.

As shown in FIG. 4A and FIG. 4B, the third radiating element 36 on the second surface 312 has a projected area at least partially overlapping with a corresponding projected area of the first radiating element 32 on the first surface 310; and the second radiating element 35 on the second surface 312 has a projected area not overlapping with a corresponding projected area of the first radiating element 32 on the first surface 310. The antenna 30, through inductive coupling of the overlapping capacity effect between the first radiating element 32 and the third radiating element 36, enables impedance match to generate a first resonant mode; and the second radiating element 35 generates a second resonant mode through inductive coupling and excitation. Therefore, the antenna 30 provides broader bandwidth and multi-frequency transmission capability compared with the prior art antenna 90, the antenna 10 in the first embodiment and the antenna 20 in the second embodiment.

As shown in FIG. 4B, the second radiating element 35 is in L shape, and the third radiating element 36 is in the shape of a rectangle; however, the second radiating element 35 and the third radiating element 36 can have any shape.

FIG. 4C illustrates a VSWR diagram of the antenna 30 under different frequencies. It is known from FIG. 4C, when VSWR is less than 2, the antenna 30 generates a first resonant mode at low frequencies and a second resonant mode at high frequencies, the antenna 30 can provide much broader bandwidth compared with the antenna 20 in the second embodiment.

Furthermore, as shown in FIG. 4D and FIG. 4E, the second radiating element 35 can be disposed not only on the second surface (back surface) 312, but also on the first surface 310 so as to be electrically coupled with the grounding element 33 directly and to achieve the effect of the invention as well.

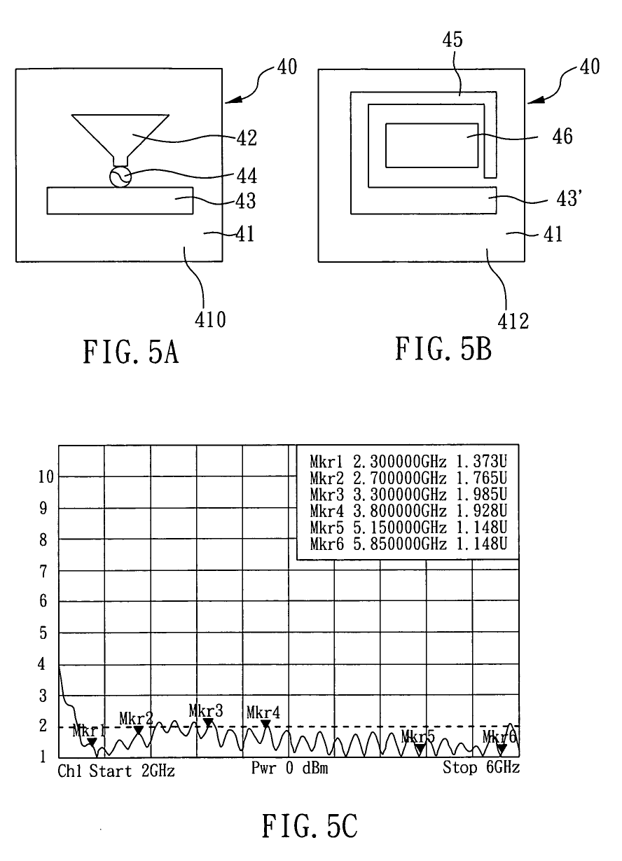

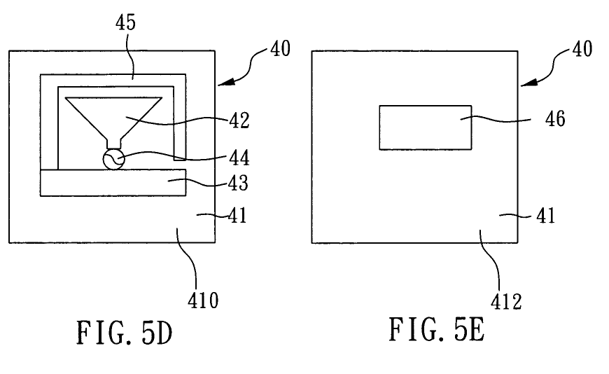

Now please refer to FIG. 5A to FIG. 5E for views of an antenna in a fourth embodiment of the invention, wherein FIG. 45 illustrates a front view of an antenna in the fourth embodiment; FIG. 5B illustrates a back view of the antenna in the fourth embodiment; FIG. 5C illustrates a VSWR diagram of the antenna in the fourth embodiment; FIG. 5D illustrates a front view of an implementation of the antenna in the fourth embodiment; and FIG. 5E illustrates a back view of the implementation of the antenna in the fourth embodiment.

As shown in FIG. 5A and FIG. 5B, an antenna 40 comprises a base board 41, a first radiating element 42, a grounding element 43 and 43′, a feeding structure 44, a second radiating element 45 and a third radiating element 46. The base board 41 comprises a first surface 410 and a second surface 412, wherein the first radiating element 42, the grounding element 43 and the feeding structure 44 are disposed on the first surface (front surface) 410 of the base board 41; the second radiating element 45, the grounding element 43′ and the third radiating element 46 are disposed on the second surface (back surface) 412 of the base board 41.

The difference between the fourth embodiment and the third embodiment is that, in the fourth embodiment, the antenna 40 uses the U-shaped second radiating element 45 instead of the L-shaped second radiating element 35 in the third embodiment.

FIG. 5C illustrates a VSWR diagram of the antenna 40 under different frequencies. It is known from FIG. 5C, when VSWR is less than 2, the antenna 40 generates a first resonant mode between 2.3 GHz and 2.7 GHz; and the antenna 40 generates a second resonant mode between 3.3 GHz and 5.8 GHz. Therefore, by changing the shape of the second radiating element 45, the antenna 40 can be applied in operating frequency bands from 2.3 GHz to 2.7 GHz and from 3.3 GHz to 3.8 GHz for WiMAX (Worldwide Interoperability for Microwave Access).

Besides, as shown in FIG. 5D and FIG. 5E, the second radiating element 45 can be disposed not only on the second surface (back surface) 412, but also on the first surface 410, and the second radiating element 45 can be electrically coupled with the grounding element 43 directly to implement the effect of the invention.

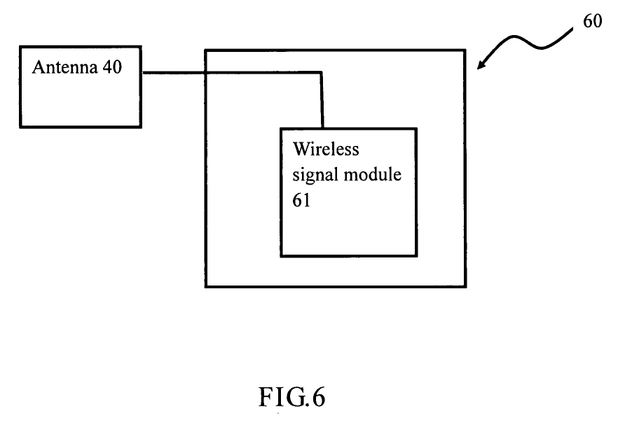

Finally, please refer to FIG. 6 for a system block diagram of an electronic device in the invention. In an embodiment of the invention, the electronic device 60 can be, but not limited to, a cellular phone, a GPS (global positioning system), a PDA (personal digital assistant) and a notebook PC. As shown in FIG. 6, the electronic device 60 comprises the antenna 40 and the wireless signal module 61. The electronic device 60 connects to the antenna 40 through an RF cable (not shown in figure) and is electrically coupled with the wireless signal module 61 for using the wireless signal module 61 to process the transmitting/receiving signals of the antenna 40. Hence, the electronic device 60 receives/transmits wireless signals from/to other devices (not shown in figure) through the antenna 40 to implement wireless communication.

It is noted that the electronic device 60 is not limited to using with the antenna 40, any one of the antenna 10, 20 or 30 can be used to replace the antenna 40 to receive or to transmit wireless signals in different frequency bands.

It is noted that the above-mentioned embodiments are only for illustration, it is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An antenna, comprising:
a base board having a first surface and a second surface;
a first radiating element disposed on the first surface for generating a first resonant mode by direct excitation;
a grounding element disposed on the first surface;
a feeding structure disposed on the first surface, wherein the first radiating element is electrically coupled with the feeding structure and the grounding element; and
a second radiating element disposed on the first surface or the second surface, wherein the second radiating element adjusts the first resonant mode or generates a second resonant mode by inductive coupling.

2. The antenna as claimed in claim 1, wherein the base board comprises a printed circuit board for the first radiating element, the grounding element and the second radiating element to be printed thereon.

3. The antenna as claimed in claim 1, wherein the second radiating element is disposed on the second surface to enable impedance match by capacity effect to adjust the first resonant mode.

4. The antenna as claimed in claim 3, wherein the second radiating element has a projected area at least partially overlapping with a corresponding projected area of the first radiating element.

5. The antenna as claimed in claim 4, wherein the second radiating element is essentially rectangular.

6. The antenna as claimed in claim 1, wherein the second radiating element is electrically coupled with the grounding element to generate the second resonant mode.

7. The antenna as claimed in claim 6, wherein the second radiating element is disposed on the second surface and the second radiating element has a projected area not overlapping with a corresponding projected area of the first radiating element.

8. The antenna as claimed in claim 6, wherein the second radiating element is essentially in L shape or U shape.

9. The antenna as claimed in claim 6 further comprising a third radiating element disposed on the second surface to enable impedance match by capacity effect to adjust the first resonant mode, wherein the third radiating element has a projected area at least partially overlapping with a corresponding projected area of the first radiating element.

10. The antenna as claimed in claim 9, wherein the second radiating element is essentially in L shape or U shape, the third radiating element is essentially rectangular, and the second radiating element essentially surrounds the third radiating element.

11. An electronic device having an antenna for wireless transmission, comprising a wireless transmission module and the antenna, wherein the wireless transmission module is electrically coupled with the antenna, and the antenna comprises:
a base board having a first surface and a second surface;
a first radiating element disposed on the first surface for generating a first resonant mode by direct excitation;
a grounding element disposed on the first surface;
a feeding structure disposed on the first surface, wherein the first radiating element is electrically coupled with the feeding structure and the grounding element; and
a second radiating element disposed on the first surface or the second surface, wherein the second radiating element adjusts the first resonant mode or generates a second resonant mode by inductive coupling.

12. The antenna as claimed in claim 11, wherein the base board comprises a printed circuit board for the first radiating element, the grounding element and the second radiating element to be printed thereon.

13. The antenna as claimed in claim 11, wherein the second radiating element is disposed on the second surface to enable impedance match by capacity effect to adjust the first resonant mode.

14. The antenna as claimed in claim 13, wherein the second radiating element has a projected area at least partially overlapping with a corresponding projected area of the first radiating element.

15. The antenna as claimed in claim 14, wherein the second radiating element is essentially rectangular.

16. The antenna as claimed in claim 11, wherein the second radiating element is electrically coupled with the grounding element to generate the second resonant mode.

17. The antenna as claimed in claim 16, wherein the second radiating element is disposed on the second surface and the second radiating element has a projected area not overlapping with a corresponding projected area of the first radiating element.

18. The antenna as claimed in claim 16, wherein the second radiating element is essentially in L shape or U shape.

19. The antenna as claimed in claim 16 further comprising a third radiating element disposed on the second surface to enable impedance match by capacity effect to adjust the first resonant mode, wherein the third radiating element has a projected area at least partially overlapping with a corresponding projected area of the first radiating element.

20. The antenna as claimed in claim 19, wherein the second radiating element is essentially in L shape or U shape, the third radiating element is essentially rectangular, and the second radiating element essentially surrounds the third radiating element.
